(19) United States
(12) Patent Application Publication
(10) Pub. No.: US 2024/0399928 A1
(43) Pub. Date: Dec. 5, 2024

(54) AIR COOLED BATTERY

(71) Applicant: Volvo Car Corporation, Göteborg (SE)

(72) Inventor: Hans Erik Olsen, Gothenburg (SE)

(21) Appl. No.: 18/325,795

(22) Filed: May 30, 2023

(51) Int. Cl. B60L 58/26; B60K 11/06; B60K 11/08

(52) U.S. Cl. CPC B60L 58/26; B60K 11/06; B60K 11/08; B60L 2240/545; B60L 2260/46

(57) ABSTRACT

A cooling system to improve cooling in a BEV battery pack colling air around an exterior side of a cooling plate and flowing it into the battery pack cell and electronics section. An air circulation system collects air surrounding the set of electronics, moves the collected air over a top side of the cooling plate to cool the air, and recirculates the cooled air over the set of electronics. The air over the cooling plate will be driven by employing a fan placed strategically to provide optimum air flow.

### TECHNICAL FIELD

The disclosed subject matter relates to utilizing a cooling plate to enhance the cooling of sensitive electronic components on a battery cell typically used in modern BEV (Battery Electric Vehicles) vehicles.

### BACKGROUND

Electric vehicles are becoming increasingly prevalent worldwide and are poised to become one of the most common modes of transportation. With this pivot in transportation technology, there exists increasing power demands on batteries or battery packs of electric vehicles. With this increased power demand, and during the use of electric vehicles, batteries of electric vehicles can become heated to a point where nearby electrical components can be exposed to these excessive temperatures. Mitigating the heat around electronics will lead to better performance and greater longevity, otherwise the heat impact can lead to reducing electric vehicle power or range and extreme damage. Eventually, battery and electrical degradation due to heat can lead to costly battery repairs or replacement of corresponding electric vehicles.

The above-described background relating to vehicle batteries and systems is merely intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products that facilitate vehicle battery health optimization are described.

As alluded to above, vehicle battery cells and the associated electronics should be properly cooled to maintain full functionality; the cooling process can be improved by various techniques, and various embodiments are described herein to such end.

According to an embodiment, an air circulation system that collects air surrounding a set of electronics, moves the collected air over a side of the cooling plate, facing away from the set of electronics, to cool the air, and recirculates the cooled air over the set of electronics. The air over the cooling plate will be driven through employing a fan placed strategically to provide optimum air flow.

According to another embodiment, an air circulation system can employ a set of tubes, ducts or a curved piece of metal such as a louver to guide air into an electronics housing to cool cells, poles, cables and any other components as required. Using a battery geometry to place the fan, tubes, ducts and or the louver to maximize the process of capturing the cool air in the unused passages and channels and transfer the air to the electronics side of the battery cell.

According to another embodiment, an air circulation system can employ temperature sensors to detect real-time temperature in a single or multiple sections in or around a battery cell and provide data to a processor that can regulate fan speed to optimize a cooling process.

According to an embodiment, a method for cooling a battery, comprises: collecting air surrounding a set of electronics of the battery; moving the collected air across a surface of a cooling plate that is facing away from the set of electronics, wherein the collected air is cooled by the cooling plate; and recirculating the cooled air across the set of electronics.

According to an embodiment, a vehicle comprises a system, wherein the system comprises: a battery housing; a set of electronics; a cooling plate wherein a first side of the cooling plate faces the set of electronics, and a second side of the cooling plate faces away from the set of electronics; and an air circulation system that collects air surrounding the set of electronics, moves the collected air over the second side of the cooling plate to cool the air, and recirculates the cooled air over the set of electronics.

### BRIEF DESCRIPTION OF DRAWINGS

FIG. 1 illustrates a diagram of a typical location of the battery cell in a BEV in accordance with one or more embodiments described herein.

FIG. 2 illustrates a basic structure of a battery pack unit in accordance with one or more embodiments described herein

FIG. 3 illustrates a diagram of an air circulating system for a battery cell in accordance with one or more embodiments described herein.

FIG. 4 illustrates a flow chart diagram in accordance with one or more embodiments described herein.

FIG. 5 depicts a basic block diagram of major components of an architecture which disclosed subject matter can interact/be implemented at least in part, in accordance with various aspects and implementations of the subject disclosure.

FIG. 6 depicts an example schematic block diagram of a computing environment with which the disclosed subject matter can interact/be implemented at least in part, in accordance with various aspects and implementations of the subject disclosure.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of one or more embodiments. It is evident, however, in various cases, that one or more embodiments can be practiced without these specific details.

A BEV stands for Battery Electric Vehicle. It is a type of electric vehicle that is powered by a battery pack that provides electricity to an electric motor. Unlike hybrid vehicles, which use a combination of an electric motor and an internal combustion engine, BEVs rely entirely on electricity for propulsion. BEVs are becoming increasingly popular as more people seek sustainable and environmentally friendly alternatives to traditional gasoline-powered vehicles. BEVs produce zero emissions at a tailpipe, and energy efficiency can be significantly higher than that of internal combustion engine vehicles, resulting in lower operating costs. However, one of the challenges of BEVs is limited driving range compared to gasoline vehicles. This has led to development of more advanced battery technologies and implementation of charging infrastructure to support longer trips. Today, some BEVs have a range of over 400 miles on a single charge, and there are a growing number of public charging stations available in many countries.

There can be some problems with BEVs, and heat is considered a primary one. Heat is an issue with many BEVs, and battery pack heat impact can lead to undesirable consequences. A typical electrical battery pack system can be described by using the following terms: cell, module and pack. A cell in a battery pack is a single unit that generates electrical energy through chemical reactions, each cell contains two electrodes—a positive electrode (cathode) and a negative electrode (anode)—which are separated by an electrolyte. Chemical reactions that occur between the electrodes and the electrolyte create a flow of electrons, which is an electrical current that can be used to power a device. Size, shape, and chemistry of a cell can vary depending on application and type of battery. For example, lithium-ion batteries, which are commonly used in portable electronics and electric vehicles, typically use a combination of lithium cobalt oxide and graphite electrodes with a liquid or gel electrolyte. Other types of batteries, such as lead-acid batteries, use lead electrodes and a sulfuric acid electrolyte.

A cell which is the basis of a battery must possess high capacity per unit volume in order to show maximum performance in a restricted area inside a vehicle and the cell also needs to have much longer lifespan compared to batteries used in general mobile devices. Furthermore, cells must endure shocks transmitted during the drive, in extreme conditions such as an accident, and therefore must possess high reliability & stability to the extent of being able to withstand high and low temperatures.

When a number of cells are put into a frame to protect them better from external shocks such as heat or vibration, this is called a module. And when a number of modules come together with a BMS (Battery Management System) and a cooling device that control and manage battery's temperature, voltage, etc., this is called a pack. This is how numerous cells are installed in an electric vehicle through the form of a pack.

In a battery pack, hottest areas are typically areas where highest amount of heat is generated during operation of the battery. Specific hotspots may vary depending on battery chemistry, cell design, and operating conditions. In general, the hottest areas in a battery pack are areas near the center of the pack where highest number of cells are located, as these cells often generate the most heat. Additionally, areas near a top of a battery pack, where heat tends to rise and accumulate, may also be hotspots. A battery tray or compartment of modern BEV cars often need an enclosure to protect the battery and its environment.

Traditionally this battery pack or compartment will be cooled with a battery cooling plate from one side. The exact appearance and design of a cooling plate will depend on the specific type of battery cell and cooling system being used. The battery cooling plate is usually located between the battery cells and the cooling system, which can consist of a liquid or air-cooling system. Heat generated by the battery cells is transferred to the cooling plate, which then transfers the heat to the cooling system to be dissipated. Effective battery cooling is critical for the long-term health and performance of the battery pack, as high temperatures can accelerate the degradation of the battery cells and reduce their lifespan. By using a battery cooling plate, the temperature of the battery cells can be kept within a safe operating range, which helps to improve efficiency, performance, and lifespan of the battery pack.

There are also electronic components that work in conjunction with the battery to drive functionality and need to be properly cooled to optimize battery performance. Electronics on a battery cell typically include a protection circuit, a monitoring circuit and other potential components. The protection circuit is designed to protect the battery cell from overcharging, over-discharging, and short-circuiting, which can cause damage to the battery cell or even result in a safety hazard. The protection circuit typically includes a fuse or a circuit breaker, as well as various electronic components such as a voltage regulator, a current limiter, and a temperature sensor. The monitoring circuit, on the other hand, is designed to measure various parameters of the battery cell, such as its voltage, current, temperature, and state of charge. This information is used to optimize the performance and safety of the battery cell, as well as to enable a battery management system (BMS) to control the charging and discharging of the battery pack. In addition to protection and monitoring circuits, some battery cells may also include other electronics such as a wireless communication module, which enables the battery pack to communicate with the vehicle's onboard computer or with external devices such as a charging station or a mobile app. The communication module can provide information such as the battery's state of charge, remaining range, and charging status, as well as enable remote monitoring and control of the battery pack.

As previously mentioned, this battery pack or compartment will be cooled with a battery cooling plate from one side of the cell. This one-sided cooling is made in order to save money and packaging space which a more surrounding cooling system would require.

Frequently one side of the battery is full of electrical cables and battery poles etc. and this side is then hard to integrate with a cooling system. The size or thickness of the battery and the single sided cooling from this cooling plate can cause a temperature gradient in the battery cells. The gradient will be both positive and negative when the battery is heated or cooled. This gradient must be in the span of possible cell temperatures, limiting the cooling and heating heat transfer as not to undercool or overheat the cells. A more uniform heat transfer from all surfaces of every single battery cell in the battery pack is a desired solution. This innovation integrates a novel heat transfer design inside a hermetic battery compartment without adding more liquid cooled cooling plates and possibly utilize unoccupied volume inside the battery compartment to benefit cooling and heating function. This is a novel method to utilize the unused surface of the water-cooled cooling plate, the side facing away from the battery cells and thermally connect this side of the cooling plate to the other side of the cells and to the cell poles and cables on the other side of the cell.

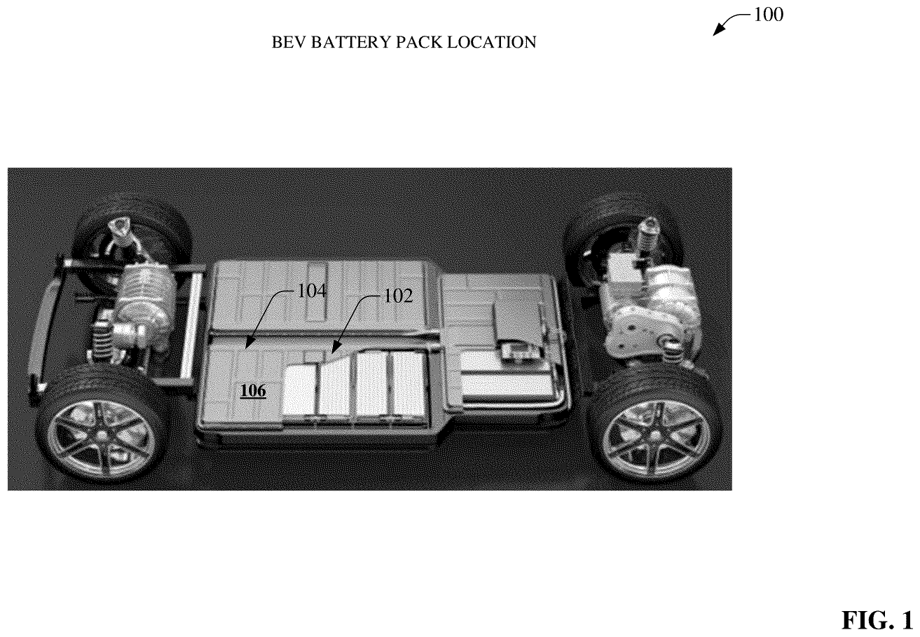

Turning now to FIG. 1, this is an illustrated example of a BEV 100 and typical locations of the battery pack 102 and battery management system 104. In a Battery Electric Vehicle (BEV), the battery pack is typically located in a floorboard 106 of the vehicle between the front and rear axles. This placement is known as the “skateboard” architecture because it creates a low center of gravity, which improves handling and stability. The pack 102 is designed to provide necessary voltage and current to power an electric motor and other systems in the vehicle 100. In some other cases, the battery pack 102 extends up into an area beneath rear seats, which creates more space for passengers and cargo. In others, the battery pack 102 can be located entirely under the floorboard 106. Exact location and configuration of the battery pack 102 can vary depending on the make and model of the vehicle 100. The Battery Management System (BMS) 104 in a Battery Electric Vehicle (BEV) is typically located near the battery pack 102, often inside or adjacent or connected to the pack (as depicted here). The BMS 104 is a critical component of the BEV 100 as it manages the charging and discharging of the battery 102, monitors the battery's state of charge and health, and protects the battery 102 from overcharging, over-discharging, and overheating. The BMS 104 is usually comprised of a collection of sensors, control modules, and software that work together to ensure the battery 102 is operating safely and efficiently. The BMS 104 communicates with other systems in the vehicle 100, such as a motor controller and a vehicle's onboard computer, to optimize performance and range of the BEV 100. Some manufacturers may integrate the BMS 104 into the battery pack 102, while others may have a separate unit that is located nearby. Exact location and design of the BMS 104 can vary depending on make and model of the BEV 100. As depicted, a driver and passengers are seated basically above or very close to these cells and the BMS. Heat can cause tremendous damage to the battery pack 102 and high temperatures around a battery pack for a battery electric vehicle (BEV) 100 can be detrimental to the battery's health and overall performance. Generally, temperatures above 40-50 degrees Celsius (104-122 degrees fahrenheit) are considered high for a battery pack. Lithium-ion batteries, which are commonly used in BEVs, are sensitive to high temperatures and can experience accelerated degradation and reduced performance when exposed to prolonged heat. At extremely high temperatures (above 60 degrees Celsius or 140 degrees fahrenheit), thermal runaway can occur, which can result in a battery fire or explosion. Proper cooling not only enhances vehicle performance, but it can also save lives.

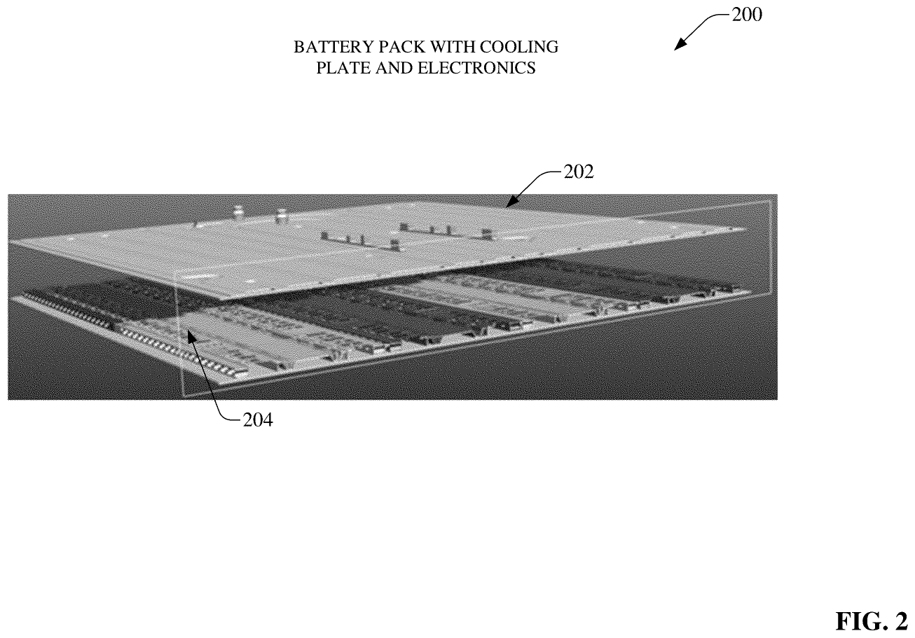

FIG. 2 depicts basics of a battery pack structure 200 reflecting a cooling plate 202 on top and an underside 204 containing the cells, poles, cables and other electronics. This underside of the battery 200 is full of electrical cables and battery poles etc. and is difficult to integrate with a cooling system. The battery cooling plate 202 is a component of the thermal management system in the battery pack 200 used in electric vehicles or other applications where high power and energy density is required. The battery cooling plate 202 is typically made of a thermally conductive material such as aluminum or copper, and its primary function is to regulate temperature of battery cells by removing excess heat generated during charging and discharging. A cooling plate on a battery cell typically looks like a thin, flat piece of metal or composite material that is designed to transfer heat away from the battery cell. The cooling plate 202 may have a series of fins or ridges on its surface to increase surface area available for heat transfer, and it may be attached directly to the surface of the battery cell 200 using adhesive or other fasteners. In some cases, the cooling plate 202 may be integrated into the battery cell itself, forming part of its outer casing or electrode structure. embodied within one or more machines form the operations described. An innovative concept is to make new connecting channels for air from top layer to bottom layer in both ends of the battery box and have a small fan blow air around the cooling plate 202 in a closed loop. Taking air from the cooling/heating plate unused upper surfaces 202 (surface facing away from electrical components of the battery cell 204 and cool any surface on the underside of the battery pack 204. This system will cool cells, poles and cables at the same time with the single cooling plate. All of this can be done without air or gas communication with the ambient by simply utilizing the cooling plate better.

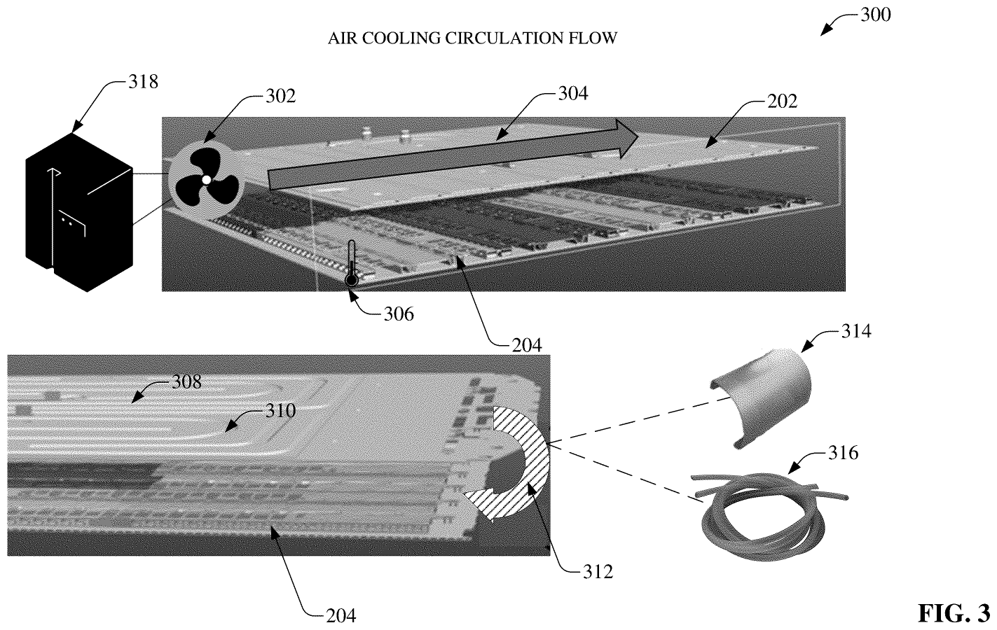

FIG. 3 depicts a diagram of an air circulating system 300 for a battery cell 204 in accordance with one or more embodiments described herein. A cooling fan 302 is at an end of the cooling plate 202 and creates air flow 304 over the cooling plate 202. This fan 302 can be placed strategically at any feasible location based on battery 204 geometry to produce optimum air flow. There are several types of cooling fans that can be used for a BEV battery pack. The type of cooling fan used can depend on various factors such as the battery pack's size, design, cooling requirements, and operating conditions. Some of the commonly used cooling fans for BEV battery packs include: Axial fans: These fans move air parallel to the axis of the fan blade and are commonly used in smaller battery packs. Radial fans: These fans move air perpendicular to the axis of the fan blade and are typically used in larger battery packs. Centrifugal fans: These fans use a rotating impeller to increase velocity and pressure of air and are commonly used in high-performance BEV battery packs. Mixed flow fans: These fans combine the characteristics of both axial and centrifugal fans and are used in battery packs that require a balance between airflow and pressure. The air flow 304 carries cooler air captured from the spaces and channels 308 & 310 on the surface to the lower compartment 204 where the cells and electronics reside. The idea is to circulate battery pack internal air in those channels to reduce the temperature gradient, cool the lower side of the battery and form a controllable air curtain between the battery cells and ambient. As the air flows to the end of the cooling plate it needs to reroute to the lower pack area (shown as 204) where the cell, poles, cables etc. reside. This rerouting can be facilitated employing various methods such using tubes or ducts 316 to capture the maximum air coming off the plate and routing it into the lower section as shown by 312. This can be executed by selective placement of the tube outputs into key channels in the lower cell area or as a whole.

There are various types of tubes that can be used to transfer air around a battery pack in an air-cooling system. Some common types include:

Plastic tubing: Plastic tubing is a flexible and lightweight option that can be easily routed through the battery pack. It is also resistant to heat, chemicals, and UV light, which makes it a durable option for use in harsh environments. Metal tubing: Metal tubing, such as aluminum or stainless steel, is a more rigid option that can be used to create a more precise and controlled air flow. It is also durable and can withstand high temperatures. Composite tubing: Composite tubing, made from materials such as carbon fiber or fiberglass, offers a lightweight and high-strength option for transferring air around a battery pack. Flexible hoses: Flexible hoses are often used in air cooling systems where the tubes need to be able to bend and flex around other components. They are usually made from materials such as silicone or rubber and can withstand high temperatures. The specific type of tubing used in an air-cooling system depends on the requirements of the application, the available space within the battery pack, and the operating conditions. Other factors that may influence the choice of tubing include cost, durability, weight, and case of installation.

Another embodiment for routing the cooler air employs a curved piece of metal such as a louver 314 or the like. A curved metal louver can transfer air by using its curved shape to deflect and redirect the airflow. The airflow is then directed by the shape of the louver and can be used to transfer air from one space to another or to exhaust air from a space. The degree of curvature of the louver can be adjusted to control the airflow rate and direction. For example, a louver with a sharper curve will create a higher-pressure difference and a faster airflow rate, while a louver with a gentler curve will create a lower pressure difference and a slower airflow rate. The angle of the louver blades can also be adjusted to direct the airflow up or down, left or right, or in a specific direction. Any of these methods will direct the air flow into this lower compartment and now an air circulation closed loop can be formed. This innovation can utilize unused cooler air on the surface that was semi stagnant previously and use it for additional cooling of the cell and electronics area 204. The cooling fan 302 depicted can be connected to the BMS or TMS (thermal management system) 318 or possibly a local controller and local power supply. For this depiction the cooling fan is connected to the BMS/TMS 318 for these functions. Cooling fans for battery packs in BEVs (Battery Electric Vehicles) can be controlled by a thermal management system that regulates the temperature of the battery pack. The thermal management system 318 includes sensors 306 that measure the temperature of the battery cells and surrounding components, and an internal control unit located within 318 that receives this information and adjusts the cooling system accordingly. The control unit may use algorithms to determine the appropriate speed and operation of the cooling fans 302, based on factors such as the temperature 306 of the battery unit, the vehicle speed, and the amount of power being used by the battery. The cooling fans can also be controlled by the vehicle's Battery Management System (BMS) 318, which monitors and controls the state of charge, temperature 306, and performance of the battery unit. The BMS 318 may adjust the cooling fans to maintain optimal operating conditions and protect the battery from damage or overheating. In some BEVs, the cooling fans 302 may also be controlled by the vehicle's climate control system, which can adjust the airflow to cool the battery pack and maintain a comfortable interior temperature for passengers.

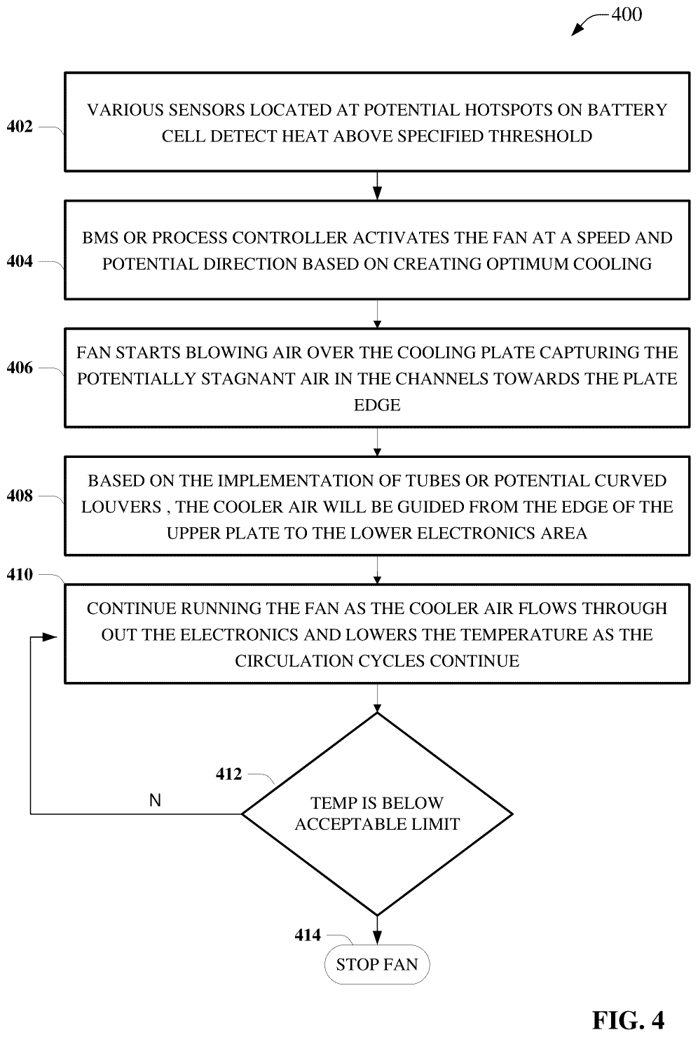

FIG. 4 depicts the steps executed to facilitate this air circulatory system. Initially the temperature sensors may have a reading that is within the acceptance range of the specifications so the fan may be off or on a steady speed, this would all be driven from the technical design. In any case when the sensors read a temperature increase 402 the cooling fan will be activated and start the air circulation process 404. As the fan instigates the air flow, cooler air resident on the surface and in the channels and indentations of the surface of the cooling plate are captured in the flow and move towards the end of the cooling plate 406. At this point, the cooler air needs to be harnessed in a way to maximize its cooling capability into the cell and electronics area below. The flowing air will be routed to the cell electronics using tubes, ducts or some type of louver 408. As the air flows throughout the cells and electronics 410, the area starts cooling and as this process continues a steady decrease in temperature or a stabilizing of temperature is the expected outcome. Based on the configuration of the design, there can be a temperature decision point which may lead to the fan being stopped 414 if a certain level or threshold is reached 412. The speed and direction of the cooling fan or fans can be controlled by a processor locally or via the BMS/TMS. This controlling entity can use temperature data along with any other driving or internal data to execute artificial intelligence algorithms to better prepare and support heating and cooling

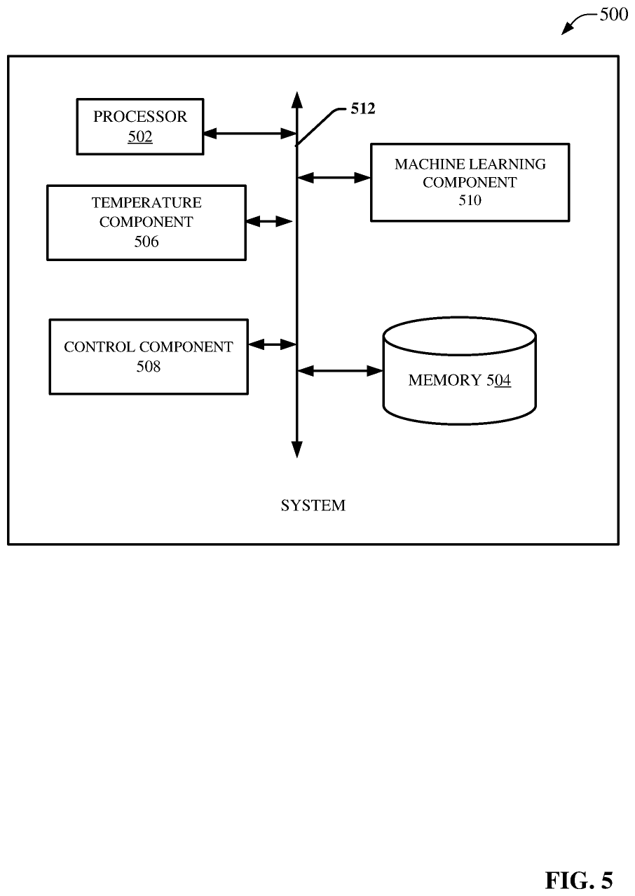

FIG. 5 depicts a basic block diagram of the major components of an architecture 500 which the disclosed subject matter can interact/be implemented at least in part, in accordance with various aspects and implementations of the subject disclosure. A processor 502 operatively connected to a memory 504 can monitor signals provided from temperature sensors 506 connected to the battery pack cooling circuit. These signals may be driven via analog or digital methods and can provide temperature readings in a real time deterministic format. There may also be speed feedback data from the fan or fans to confirm the settings are matching with actual fan performance. The processor 502 can utilize various methods to control component 508 that drives fan speed and possible direction, this may include options such a digital setting or even micro variable speed drives to create smooth up and down ramping cycles. An AI or machine learning component 510 may also interact with the system and can learn trends and patterns over time and predict possible temperature spikes before they occur to optimize system performance.

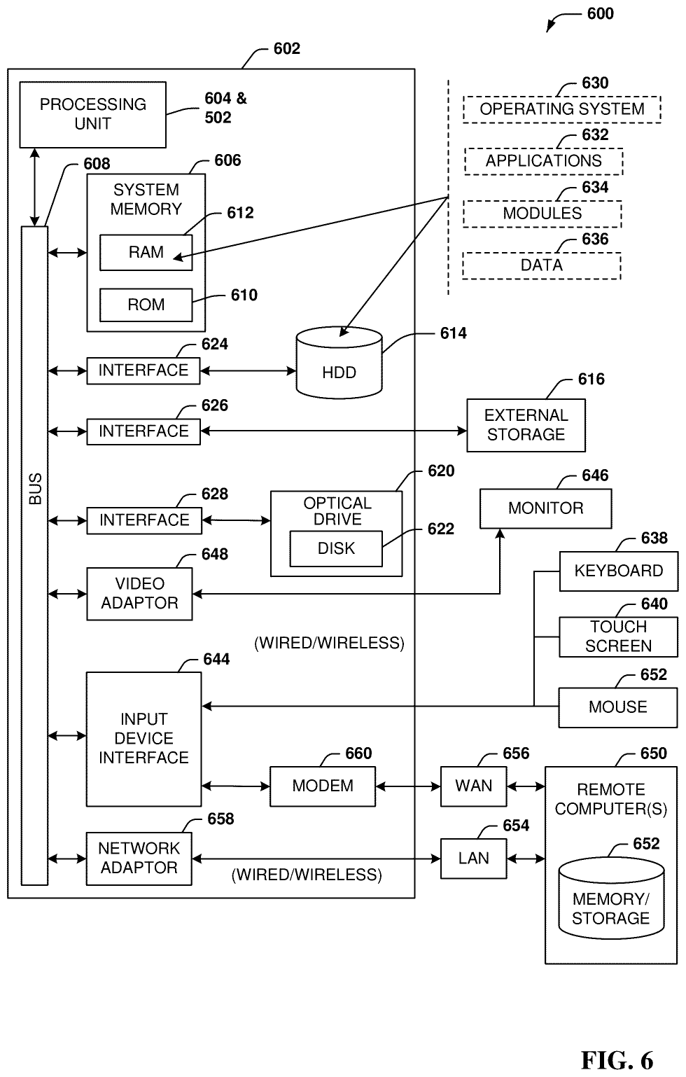

FIG. 6 depicts an example schematic block diagram 600 of a computing environment with which the disclosed subject matter can interact/be implemented at least in part, in accordance with various aspects and implementations of the subject disclosure. The example environment 600 for implementing various embodiments of the aspects described herein includes a computer 602, the computer 602 including a processing unit 604, a system memory 606 and a system bus 608. The system bus 608 couples system components including, but not limited to, the system memory 606 to the processing unit 604. The processing unit 604 can be any of various commercially available processors and may include a cache memory. Dual microprocessors and other multi processor architectures can also be employed as the processing unit 604.

The system bus 608 can be any of several types of bus structure that can further interconnect to a memory bus (with or without a memory controller), a peripheral bus, and a local bus using any of a variety of commercially available bus architectures. The system memory 606 includes ROM 610 and RAM 612. A basic input/output system (BIOS) can be stored in a non-volatile memory such as ROM, erasable programmable read only memory (EPROM), EEPROM, which BIOS contains the basic routines that help to transfer information between elements within the computer 602, such as during startup. The RAM 612 can also include a high-speed RAM such as static RAM for caching data.

The computer 602 further includes an internal hard disk drive (HDD) 614 (e.g., EIDE, SATA), one or more external storage devices 616 (e.g., a magnetic floppy disk drive (FDD) 616, a memory stick or flash drive reader, a memory card reader, etc.) and an optical disk drive 620 (e.g., which can read or write from a CD-ROM disc, a DVD, a BD, etc.). While the internal HDD 614 is illustrated as located within the computer 602, the internal HDD 614 can also be configured for external use in a suitable chassis (not shown). Additionally, while not shown in environment 600, a solid-state drive (SSD) could be used in addition to, or in place of, an HDD 614. The HDD 1314, external storage device(s) 616 and optical disk drive 620 can be connected to the system bus 608 by an HDD interface 624, an external storage interface 626 and an optical drive interface 628, respectively. The interface 624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 612, including an operating system 630, one or more application programs 632, other program modules 634 and program data 636. All or portions of the operating system, applications, modules, and/or data can also be cached in the RAM 612. The systems and methods described herein can be implemented utilizing various commercially available operating systems or combinations of operating systems.

Computer 602 can optionally comprise emulation technologies. For example, a hypervisor (not shown) or other intermediary can emulate a hardware environment for operating system 630, and the emulated hardware can optionally be different from the hardware illustrated in FIG. 6. In such an embodiment, operating system 630 can comprise one virtual machine (VM) of multiple VMs hosted at computer 602. Furthermore, operating system 630 can provide runtime environments, such as the Java runtime environment or the .NET framework, for applications 632. Runtime environments are consistent execution environments that allow applications 632 to run on any operating system that includes the runtime environment. Similarly, operating system 630 can support containers, and applications 632 can be in the form of containers, which are lightweight, standalone, executable packages of software that include, e.g., code, runtime, system tools, system libraries and settings for an application.

Further, computer 602 can comprise a security module, such as a trusted processing module (TPM). For instance with a TPM, boot components hash next in time boot components, and wait for a match of results to secured values, before loading a next boot component. This process can take place at any layer in the code execution stack of computer 602, e.g., applied at the application execution level or at the operating system (OS) kernel level, thereby enabling security at any level of code execution.

A user can enter commands and information into the computer 602 through one or more wired/wireless input devices, e.g., a keyboard 638, a touch screen 640, and a pointing device, such as a mouse 642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 604 through an input device interface 644 that can be coupled to the system bus 608, but can be connected by other interfaces, such as a parallel port, an IEEE 1394 serial port, a game port, a USB port, an IR interface, a BLUETOOTH® interface, etc.

A monitor 646 or other type of display device can be also connected to the system bus 608 via an interface, such as a video adapter 648. In addition to the monitor 646, a computer typically includes other peripheral output devices (not shown), such as speakers, printers, etc.

The computer 602 can operate in a networked environment using logical connections via wired and/or wireless communications to one or more remote computers, such as a remote computer(s) 650. The remote computer(s) 650 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 652 is illustrated. The logical connections depicted include wired/wireless connectivity to a local area network (LAN) 654 and/or larger networks, e.g., a wide area network (WAN) 656. Such LAN and WAN networking environments are commonplace in offices and companies, and facilitate enterprise-wide computer networks, such as intranets, all of which can connect to a global communications network, e.g., the internet.

When used in a LAN networking environment, the computer 602 can be connected to the local network 654 through a wired and/or wireless communication network interface or adapter 658. The adapter 658 can facilitate wired or wireless communication to the LAN 654, which can also include a wireless access point (AP) disposed thereon for communicating with the adapter 658 in a wireless mode.

When used in a WAN networking environment, the computer 602 can include a modem 660 or can be connected to a communications server on the WAN 656 via other means for establishing communications over the WAN 656, such as by way of the internet. The modem 660, which can be internal or external and a wired or wireless device, can be connected to the system bus 608 via the input device interface 644. In a networked environment, program modules depicted relative to the computer 602 or portions thereof, can be stored in the remote memory/storage device 652. It will be appreciated that the network connections shown are example and other means of establishing a communications link between the computers can be used.

When used in either a LAN or WAN networking environment, the computer 602 can access cloud storage systems or other network-based storage systems in addition to, or in place of, external storage devices 616 as described above. Generally, a connection between the computer 602 and a cloud storage system can be established over a LAN 654 or WAN 656 e.g., by the adapter 658 or modem 660, respectively. Upon connecting the computer 602 to an associated cloud storage system, the external storage interface 626 can, with the aid of the adapter 658 and/or modem 660, manage storage provided by the cloud storage system as it would other types of external storage. For instance, the external storage interface 626 can be configured to provide access to cloud storage sources as if those sources were physically connected to the computer 602.

The computer 602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

Various non-limiting aspects of various embodiments described herein are presented in the following clauses.

Clause 1: A system for cooling a battery, comprising: a battery housing; a set of electronics; a cooling plate wherein a first side of the cooling plate faces the set of electronics, and a second side of the cooling plate faces away from the set of electronics; an air circulation system that collects air surrounding the set of electronics, moves the collected air over the second side of the cooling plate to cool the air, and recirculates the cooled air over the set of electronics.

Clause 2: The system of any preceding clause, wherein the cooling plate lowers the temperature of the collected air.

Clause 3: The system of any preceding clause, the circulation system comprising a fan.

Clause 4: The system of any preceding clause, the circulation system further comprising a set of tubes running across the second side of the cooling plate.

Clause 5: The system of any preceding clause, further comprising a set of temperature sensors.

Clause 6: The system of any preceding clause, further comprising a processor that facilitates controlling speed of air circulation.

Clause 7: The system of any preceding clause, further comprising an artificial intelligence model that learns temperature control of the battery.

Clause 8: The system of any preceding clause, the circulation system further comprising of a piece of curved metal such as a louver to guide the circulated air to the area containing the electronics.

Clause 9: The system of any preceding clause, further comprising of fan mounting accessories based on battery geometry.

Clause 10: The system of any preceding clause, further comprising of a local battery or battery management system connection to power the fan.

Clause 11: The system of any preceding clause, further comprising of electronic components on the underside of the battery pack such as cells, poles, cables.

Clause 12: A method for cooling a battery, comprising: collecting air surrounding a set of electronics of the battery; moving the collected air across a surface of a cooling plate that is facing away from the set of electronics of the battery, wherein the collected air is cooled by the cooling plate; and recirculating the cooled air across the set of electronics of the battery.

Clause 13: The method of any preceding clause, further comprising using a fan to collect and circulate the collected air.

Clause 14: The method of any preceding clause, further comprising using a set of tubes running across the cooling plate or a louver to move the collected air.

Clause 15: The method of any preceding clause, further comprising using a set of temperature sensors to monitor temperature of the collected air.

Clause 16: The method of any preceding clause, further comprising using a processor to facilitate controlling speed of air circulation.

Clause 17: The method of any preceding clause, further comprising using an artificial intelligence model that learns temperature control of the battery.

Clause 18: A vehicle, comprising a system for cooling a battery, comprising: a battery housing; a set of electronics; a cooling plate wherein a first side of the cooling plate faces the set of electronics, and a second side of the cooling plate faces away from the set of electronic, wherein the cooling plate lowers the temperature of the collected air; an air circulation system that collects air surrounding the set of electronics, and a fan to drive the collected air over the second side of the cooling plate to cool the air, and recirculates the cooled air over the set of electronics.

Clause 19: The vehicle of any preceding clause, the circulation system further comprising a set of tubes running across the second side of the cooling plate.

Clause 20: The vehicle of any preceding clause, further comprising a processor that facilitates controlling speed of air circulation, and an artificial intelligence model that learns temperature control of the battery.

In various cases, any suitable combination of clauses 1-11 can be implemented.

In various cases, any suitable combination of clauses 12-17 can be implemented.

In various cases, any suitable combination of clauses 18-20 can be implemented.

What is claimed is:

1. A system for cooling a battery, comprising:
a battery housing;
a set of electronics;
a cooling plate wherein a first side of the cooling plate faces the set of electronics, and a second side of the cooling plate faces away from the set of electronics; and
an air circulation system that collects air surrounding the set of electronics, moves the collected air over the second side of the cooling plate to cool the air, and recirculates the cooled air over the set of electronics.

2. The system of claim 1, wherein the cooling plate lowers temperature of the collected air.

3. The system of claim 1, the circulation system comprising a fan.

4. The system of claim 1, the circulation system further comprising a set of tubes running across the second side of the cooling plate.

5. The system of claim 1, further comprising a set of temperature sensors.

6. The system of claim 1, further comprising a processor that facilitates controlling speed of air circulation.

7. The system of claim 6, further comprising an artificial intelligence model that learns temperature control of the battery.

8. The system of claim 1, the circulation system further comprising a louver to guide the circulated air to an area containing the electronics.

9. The system of claim 1, further comprising fan mounting accessories based on battery geometry.

10. The system of claim 3, further comprising a battery management system to power the fan.

11. The system of claim 1 further comprising electronic components on an underside of a battery pack wherein the electronic components comprise at least one of: cells, poles, or cables.

12. A method for cooling a battery, comprising:
collecting air surrounding a set of electronics of the battery;
moving the collected air across a surface of a cooling plate that is facing away from the set of electronics, wherein the collected air is cooled by the cooling plate; and
recirculating the cooled air across the set of electronics.

13. The method of claim 12, further comprising using a fan to collect and circulate the collected air.

14. The method of claim 12, further comprising using a set of tubes running across the cooling plate or a louver to move the collected air.

15. The method of claim 12, further comprising using a set of temperature sensors to monitor temperature of the collected air.

16. The method of claim 12, further comprising using a processor to facilitate controlling speed of air circulation.

17. The method of claim 16, further comprising using an artificial intelligence model that learns temperature control of the battery.

18. A vehicle comprising:
a system, wherein the system comprises:
a battery housing;
a set of electronics; and
a cooling plate wherein a first side of the cooling plate faces the set of electronics, and a second side of the cooling plate faces away from the set of electronics; and
an air circulation system that collects air surrounding the set of electronics, moves the collected air over the second side of the cooling plate to cool the air, and recirculates the cooled air over the set of electronics.

19. The vehicle of claim 18, the circulation system further comprising a set of tubes running across the second side of the cooling plate.

20. The vehicle of claim 18, further comprising a processor that facilitates controlling speed of air circulation, and an artificial intelligence model that learns temperature control of the battery.
